(19) United States
(12) Patent Application Publication
(10) Pub. No.: US 2008/0284108 A1
(43) Pub. Date: Nov. 20, 2008

(54) SEAL

(76) Inventor: Brenton James Davey, South Australia (AU)

Correspondence Address: DECKER, JONES, MCMACKIN, MCCLANE, HALL &;BATES, P.C., BURNETT PLAZA 2000, 801 CHERRY STREET, UNIT #46, FORT WORTH, TX, 76102-6836, US

(21) Appl. No.: 12/119,851

(22) Filed: May 13, 2008

Related U.S. Application Data
(63) Continuation of application No. 11/477,064, filed on Jun. 28, 2006, now abandoned.
Application No. 11/477,064 is a continuation of application No. 10/416,150, filed on May 8, 2003, now abandoned.

(30) Foreign Application Priority Data
Nov. 9, 2000 (AU) PR 1312
Jul. 19, 2001 (AU) PR 6451

(51) Int. Cl. F16J 15/34

(52) U.S. Cl. 277/399

(57) ABSTRACT

A bellows type seal for a quick connect coupling. The bellows seal has a torroidal portion (20) with a substantially planar sealing surface at one end of the torroidal portion (20) and a bellows portion (14) at the other end of the torroidal portion (20). The bellows portion (14) extends away from the torroidal portion (20) and is semicircular in cross-section and terminates in a circumferential bead (24) extending radially outward from the bellows portion (14). The bellows portion (14) may also include a circumferential sealing bead (26) at an apex of the bellows portion (14). The torroidal portion (20) may have a metal reinforcement ring (22). The termination bead (24) of the bellows portion (14) has a part circular cross-section with a diameter greater than that of the thickness of the bellows portion (14).

### CROSS-REFERENCE

This application is a continuation application of U.S. Ser. No. 11/477,064, filed Jun. 28, 2006, which is a continuation of U.S. application Ser. No. 10/416,150, filed May 8, 2003, which claims priority to PCT International Application No. PCT/AU01/01448 filed Nov. 9, 2001, which application claimed priority to Australian Patent Applications PR1312, filed Nov. 9, 2000 and PR 6451, filed Jul. 19, 2001.

### FIELD OF THE INVENTION

The following invention relates to an improved seal for fluid sealing applications particularly seals for fluid coupling.

### BACKGROUND OF THE INVENTION

The invention will have numerous applications, but will generally be suited to forming a seal between two components. One of the components may comprise another sealing element. For example, the seals according to the invention will be particularly suited to use with the cam lock coupling or quick connect couplings between fluid pipes of the type shown in Australian Patent No. 551172.

The quick connect couplings have a seal located in each coupling element. The couplings are held together by inter-engaging claws and each seal abuts against the seal located in the adjoining coupling.

The seals of this type are generally shown in the above-mentioned Australian Patent and comprise an annular ring having a substantially planar sealing face which projects from each of the couplings. As the couplings are connected each of these faces abut the other and the connection process results in some compression of the seals to assist in sealing between these faces.

The remainder of the seal can vary depending on the type of coupling. However, a common type of seal is that known as the bellows seal which is shown in the above-mentioned Australian Patent. The bellow portion of the seal fits within a correspondingly shaped cavity within the coupling head.

The bellows portion of the seal has a generally semicircular cross-section extending from the annular seal to a portion known as the lip. The lip extends in a generally horizontal direction in a plane which is normal to the axis of the coupling.

Forming a seal with such quick connect couplings has two performance limitations. These are forming a seal at low pressures and the maximum pressure obtainable before the seals fail.

At low pressures, there is the possibility that the seal may not be properly seated within the coupling thereby providing a means of escape of fluid. As the pressure within the coupling increases, the bellows portion of the seal is forced into its cavity to thereby create a fluid tight seal. It is generally accepted that the lip portion of the seal, being more flexible, is able to deform readily at low pressures to therefore form an effective seal as a line is pressurized. This is a generally accepted design principal in respect of this type of seal.

The annular portions of the seal extend a short distance from the face of the coupling. This is to ensure that the annular portions of the two adjoining seals actually abut. However, at high pressure, these portions can be forced in a radial direction to the extent where the seal is broken and pressure is released.

Accordingly, it is an aim in relation to the design of quick connect couplings to improve these two operating characteristics. It is also an aim of the invention to provide a seal which has better sealing characteristics upon assembly of the components to the seal so that an adequate working seal is formed upon initial pressurization of the coupling.

### BRIEF DESCRIPTION OF THE INVENTION

Accordingly, in its broadest form, the invention comprises a seal for, in use, forming a fluid type seal between two components, the seal including;

two spaced apart sealing edges or surfaces;

a resiliently deformable portion between said two spaced apart sealing edges or surfaces so that a compressive force moves said two spaced apart sealed edges or surfaces together; and

at least one of said sealing edges or surfaces comprising a ridge extending away from said resiliently deformable portion.

As will be understood from the description of the quick connect couplings, one of the components against which the seal may abut may be another seal mounted in another quick connect coupling.

Preferably, the seal is annular although it may also comprise a more irregular shape in outline. Accordingly, a shape such as rectangular outlines or combination of straight lines and curves would also be encompassed by the invention.

The resiliently deformable portion may comprise a number of different shapes. It may comprise a semicircular shape in cross-section similar to the typical bellow seal illustrated in Australian Patent No. 551172. Alternatively, any shape may be used which deflects when a compressive force is applied. In other words, deflection of the deformable portion is required rather that compression of the seal material. This may be achieved by ensuring that the compressive force acting through one sealing edge or surface is radially spaced with respect to the second sealing edge or surface so that a bending moment between the adjoining portion of the seal is created which may result in deflection of this portion. It will be understood that when describing the portion as resiliently deformable, deflection of this portion would also fall within the meaning of deformable.

The ridge may comprise any formation which is designed to form a seal at some point on its surface. For example, the ridge may comprise a bead having a part circular cross-section that extends from the end of the deformable portion. Alternatively, the ridge may comprise a free edge of the deformable portion.

Preferably, axial force applied to the other sealing surface results in the ridge being forced into sealing contact with the component in which it is engaged.

This invention enables the seal to be manufactured from sealing compounds having a high degree of hardness by comparison to previous seals. The designers of such seals have always thought that soft grades of rubbers were required in order for the bellow seals shown in Australian Patent No. 551172 to function. It is thought that maximum compliance enables the seals to form a fluid type seal at low pressures. Accordingly, it has been the practice in the past to use soft compounds.

The current invention, however, enables harder compounds to be used. Accordingly, another aspect of the invention comprises a seal manufactured from harder compounds having two spaced sealing edges or surfaces with a resiliently deformable portion located between wherein the resiliently deformable portion enables movement of the two sealing edges or surfaces together when a compressive force is applied to the seal so that the ridge is forced against the sealing surface within the component in which it is located.

By comparison, the prior art seals of the type shown in Australian Patent No. 551172 had a flexible lip so that any compressive force applied to the seal would not result in the lip being forced against the adjacent portion of the coupling. It generally remained flexible and able to freely move while a compressive force was being applied to the seal.

The use of a harder compound for manufacturing the seal results in the annular portion of the seals used in the quick connect couplings being able to withstand larger hoop stresses and therefore maintaining a fluid tight seal at high pressure. This would also improve the sealing effect between adjacent seals even though there was some degree of misalignment between the annular sealing surfaces.

Another advantage of using harder material is that the wall thickness of the annular seal portion can be made thinner to thereby increase the internal diameter or bore through the seal. This improves flow rate characteristics through the seal. In addition, the gap between adjacent quick connect couplings can be increased as the annular portions of the seal can withstand a greater bending moment.

In a further aspect of the invention, a combination of compounds may be used to produce the seal. For example, a softer grade of rubber may be used in those regions where adjacent sealing surfaces abut. This will provide an enhanced seal in this location while at the same time maintaining the rigidity through the use of harder rubbers in other areas.

Further, in order to increase the pressure that can be maintained by the seals, metal components may be molded into the seal to provide additional radial rigidity. This will prevent the extrusion of the abutting sealing edges radially outwardly which results in failure of the seal and release of pressure.

The ridge referred to above preferably has a part circular cross-section but may also comprise any other form of shape such as a triangular cross-section or a cross-section having a flat seal forming surface. Ideally, the ridge maintains sealing contact during deformation of the deformable portion. This may result in some rotation of the ridge with respect to the component against which it seals so preferably, the ridge is shaped so as to maintain sealing contact with the component during such movement.

Preferably, the resiliently deformable portion provides adequate spring force to ensure that the seals are held square in the component within which it is installed and ensures that sufficient force is applied to the sealing surfaces or edges to effect a seal. Accordingly, the spring force can be varied within the deformable portion, such as by varying wall thickness, so that dependant on the extent of crush, resulting from assembly of the components, then the required sealing force is applied.

The ridge may be located axially under the other sealing surface or edge or at least is located axially under the line of force which is applied to the other sealing edge or surface. Accordingly, the deformable portion will preferably be a bellows style or similar to ensure deformability. This configuration ensures that the compressive force is transferred axially to the ridge to ensure that the maximum force is applied by the ridge to the sealing surface against which it abuts.

In a further form the invention may be said to reside in bellows type seal for a quick connect coupling, the bellows seal having

a torroidal portion having a substantially planar sealing surface at one end of the torroidal portion and a bellows portion at the other end of the torroidal portion, the bellows portion extending away from the torroidal portion, the bellows portion being semicircular in cross-section and terminating in a circumferential bead portion extending radially outward from the bellows portion.

Preferably the bellows portion also includes a circumferential sealing bead at an apex of the bellows portion.

The torroidal portion may include a metal reinforcement ring.

The termination bead of the bellows portion may have a part circular cross-section having a diameter greater than that of the thickness of the bellows portion.

Preferably the bellows portion is more compressible than the torroidal portion to thereby provide resilient force to enable the sealing surface on the torroidal portion to seal against another planar surface. Such another planar surface may be a corresponding sealing surface on another bellows type seal according to this invention.

In a further form the invention is said to reside in a fluid coupling comprised of two coupling members having hollow bodies interengageable the one with the other by means of lugs on each engaging shaped flanges on the other, and each having a sealing ring in an annular recess positioned to interengage the one with the other to sealingly place the hollow of one coupling member into communication with the hollow f the other coupling member, wherein each sealing ring includes a torroidal portion having a substantially planar sealing surface at one end of the torroidal portion and a bellows portion at the other end of the torroidal portion, the bellows portion extending away from the torroidal portion, the bellows portion being semicircular in cross-section and terminating in a bead portion, the bellow portion being adapted to engage in the annular recess and the bead portions adapted to engage with the surface of the annular recess.

### BRIEF DESCRIPTION OF THE INVENTION

In order to fully understand the invention preferred embodiments of the seal will now be described. However, it should be realised that the invention is not to be limited in its scope to any one of these preferred embodiments.

In the drawings:

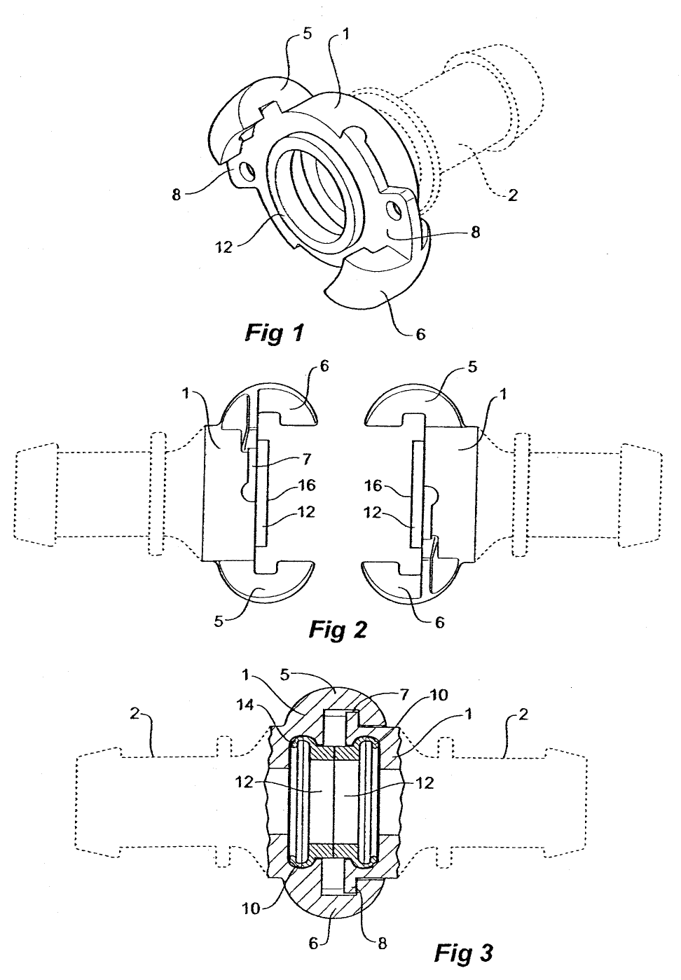

FIG. 1 shows a quick connect coupling of the type to which the present invention is directed and used upon.

FIG. 2 shows two quick connect couplings in the ready to connect position.

FIG. 3 shows a cross-sectional view of a connected quick connect coupling;

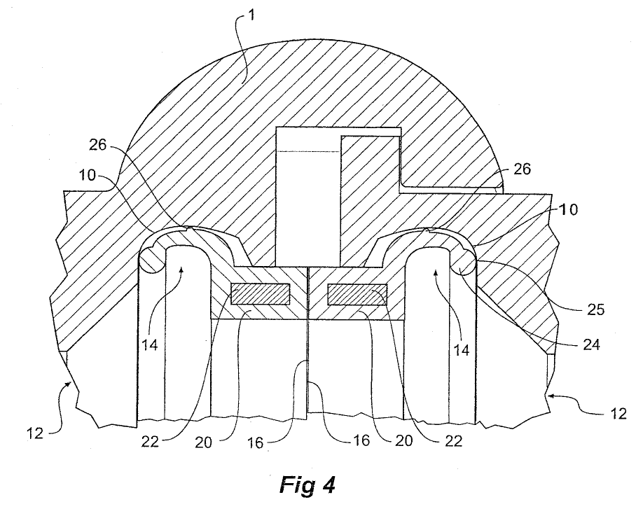

FIG. 4 shows a connected quick connect coupling in detail showing the seal ring.

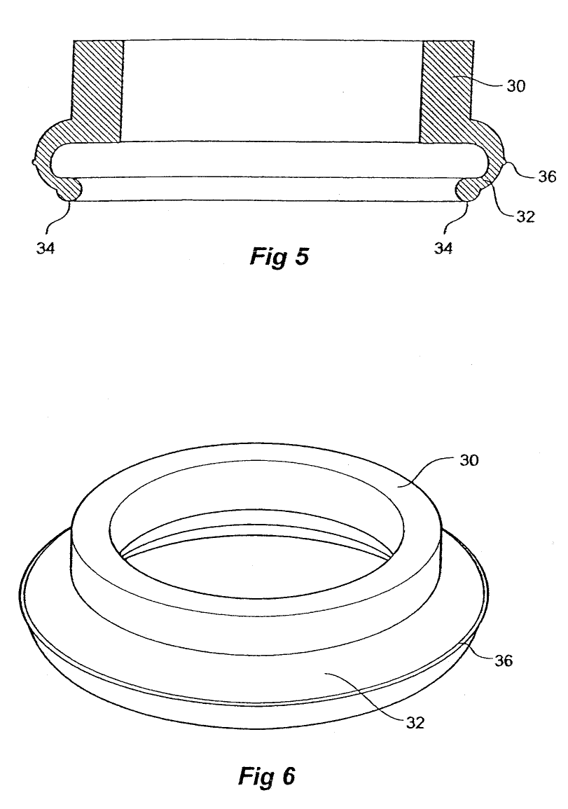

FIG. 5 shows a cross-sectional view of a seal ring according to this invention.

FIG. 6 shows a perspective view of a seal ring according to this invention.

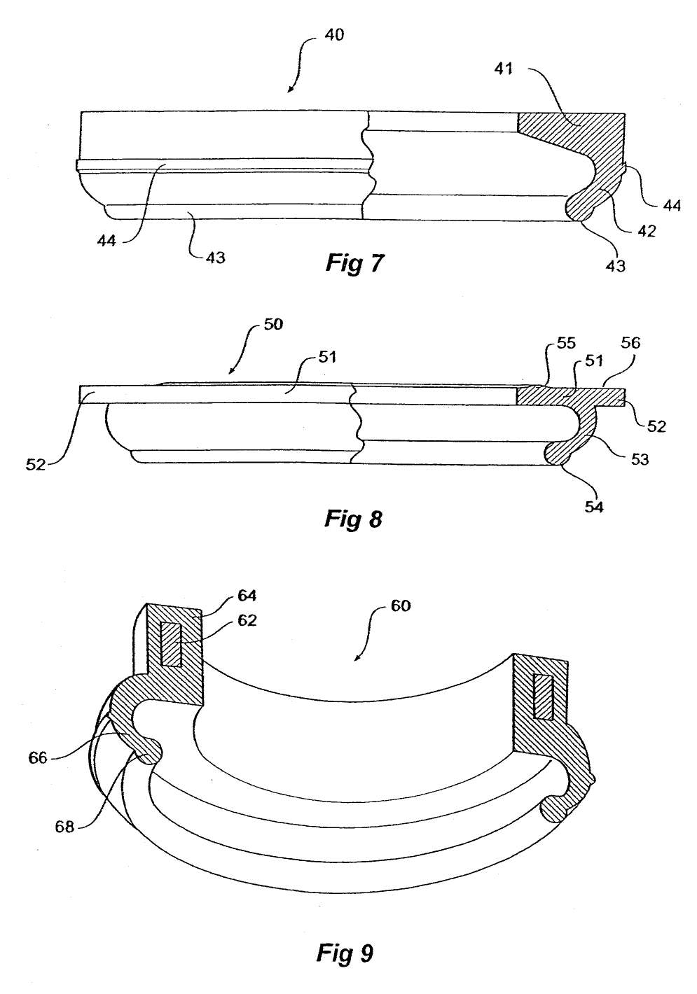

FIG. 7 shows a cross-sectional view of an alternative embodiment of a seal ring according to this invention

FIG. 8 shows a still further embodiment of a seal ring according to this invention; and

FIG. 9 shows a cross-sectional view of a further embodiment of a seal ring according to this invention.

### DESCRIPTION OF PREFERRED EMBODIMENTS

Now looking more closely to the drawings and in particular the quick connect coupling shown in FIGS. 1 to 3 it will be seen that the and each quick connect coupling which are in fact identical in configuration have a body 1 with a tail 2 to which a pipe may be connected for transferring fluids such as a liquid or compressed air. The tail may also be internally or externally threaded. The fitting has hooked shaped lugs 5 and 6 constructed according to well known principles. In use the lugs 5 and 6 on the body engage flanges 7 and 8 on a further fitting to which it is to be connected.

Each fitting has in it an internal annular recess 10 as can best be seen in FIG. 3 and into this is fitted a seal ring generally shown as 12. Each sealing ring 12 has a resilient bellows portion 14 received in the annular recess 10 and a forward sealing face 16 which seals against the corresponding sealing face of another sealing ring when the joint is coupled.

As can be seen in detail in FIG. 4 when a connection is made the receptive seal faces 16 on seal ring 12 engage to form a seal and the bellows portion 14 is received in the recess 10 in the body 1.

The seal ring 12 in general comprises a torroidal portion 20 which in this embodiment has a steel reinforcing ring 22 in it and a bellows portion 14 terminating in a circumferential sealing bead or ridge 24. It may be noted that a portion 25 of the bead 24 extends radially outwards from the bellows portion 14. There is also a circumferential sealing bead or ridge 26 at the apex of the bellows portion 14.

There is sufficient resiliency in the bellows portion when two connectors are connected so that at low pressure the radially outward projecting portion of the bead 25 engages against the surface of the recess 10 and provides sealing for fluid at low pressure in the connector and that higher pressure, the pressure forces the bellows portion against the surface of the recess 10 and with the sealing bead 26 provides a good sealing.

The torroidal portion 20 can be made from a relatively hard rubber and in this embodiment which uses the metal ring 22 deformation of the sealing torroid at high pressure cannot occur.

It will be noted that when the sealing surface 16 abuts against the sealing surface of an adjacent seal ring when the quick connect couplings are brought together the seal 12 is slightly compressed so that the bellows portion 14 is deformed slightly which transfers a compressive force to the bead or ridge 25. The deformation of the bellows position 14 results in a slight rotation of the bead portion 25 however due to the part circular cross-section of the bead 25 it always presents a sealing edge to the inner surface of the annular groove.

The hardness of the rubber compound used to form the seal ring 12 can be varied depending on the degree of compression imparted upon the connection and the expected pressure to be carried by the fluid in the joint. With a smaller extent of compression the material may be stiffer to in turn impart the required sealing force to the sealing bead 25. In addition the cross-sectional thickness of the bellows portion 14 may be varied to obtain the required sealing force.

FIGS. 5 and 6 show an alternative embodiment of a seal ring according to this invention. In this embodiment the seal ring has a torroidal portion 30 and a bellows portion 32. There is no metal ring in the torroidal portion 30. The bellows portion has a bead or ridge 34 at its terminal end and a bead or ridge 36 at its apex.

FIG. 7 shows an alternative embodiment of seal ring according to this invention in part cross-section. The seal ring 40 has an annular portion 41 and a bellows portion 42 with the bellows portion terminating in a seal bead or ridge 43. A circumferential seal ridge or bead 44 is provided at the apex of the bellows portion 42. This seal ring 40 is adapted for mounting into a quick connect coupling which does not require an undercut recess to be machined to fit the seal ring. Instead the coupling requires only a much simpler opening within which to locate the seal. It would be possible to use a cylindrical wall bore with a flat base within which to seat the seal ring shown in FIG. 7. Alternatively the bore or recess can be formed with a circular fillet in the base to match the shape of the seal ring 40 as shown in FIG. 5.

FIG. 8 shows a still further embodiment of seal ring according to this invention.

In this embodiment the seal ring 50 includes a torroidal portion 51 which incorporates an outwardly extending radial flange 52 and on the bellows portion 53 is the sealing bead 54.

This embodiment also includes a projection 55 on the planar sealing surface 56 of the torroidal portion 51.

FIG. 9 shows a further embodiment of seal ring according to this invention which is similar to that shown in FIGS. 5 and 6 but with the inclusion of a metal reinforcement ring 62 in the torroidal portion 64. The reinforcement ring 62 is held in place within the mould cavity prior to injection of the rubber compound. Moulding of the seal 60 around the ring 62 results in the rubber compound encapsulating the reinforcement ring 62.

The reinforcement ring 62 prevents the radial expansion of the sealing portion 64 and therefore enables a butting seal to withstand much higher pressure. Under high pressure the torroidal seal portions may tend to displace radially to such an extent that an effective seal is no longer formed between the sealing surfaces but the inclusement of the reinforcement ring 62 greatly improves the high pressure capability of the seal rings.

This embodiment of seal ring 60 also has a bellows portion 66 terminating in a circumferentially extending bead or ridge 68.

As can be seen from the above description the invention provides a significant improvement to seal rings used in quick connect couplings. In particular the seal ring enables inadequate low pressure seal to be formed in a quick connect coupling while at the same time providing a means of increasing maximum pressure that the seals can maintain.

Throughout the specification various indications have been given as to the scope of the invention but the invention is not limited to one of these but may reside in two or more of these combined together. The examples are given for illustration only and not for limitation.

1-4. (canceled)

5. An annular seal as in claim 22 wherein said ridge has a part circular cross-section.

6-8. (canceled)

9. An annular seal as in claim 22 further including a metal component molded into said first annular portion to provide additional radial rigidity.

10-12. (canceled)

13. A bellows type seal for a quick connect coupling, the bellows seal comprising an annular portion having a substantially planar sealing surface at one end of the annular portion and a bellows portion at the other end of the annular portion, the bellows portion extending away from the annular portion, the bellows portion being curved in cross-section and terminating in a circumferential bead portion having an arcuate cross-section thereby forming a second annular sealing surface.

14. A bellows type seal for a quick connect coupling as in claim 13 wherein the bellows portion also includes a circumferential sealing bead at an apex of the bellows portion.

15. A bellows type seal for a quick connect coupling as in claim 13 wherein the annular portion includes a metal reinforcement ring.

16. A bellows type seal for a quick connect coupling as in claim 13 wherein the termination bead of the bellows portion has a part circular cross-section having a diameter greater than that of the thickness of the bellows portion to which it is attached.

17. (canceled)

18. A fluid coupling comprised of two coupling members having hollow bodies interengageable the one with the other by means of lugs on each engaging shaped flanges on the other, and each having an annular seal located in an annular recess positioned to interengage the one with the other to sealingly place the hollow of one coupling member into communication with the hollow of the other coupling member, wherein each annular seal includes an annular portion having a substantially planar sealing surface at one end of the annular portion and a bellows portion at the other end of the annular portion, the bellows portion extending away from the annular portion, the bellows portion being curved in cross-section and terminating in a bead portion having an arcuate cross-section, the bellows portion being adapted to engage in the annular recess and the bead portion adapted to engage with the surface of the annular recess thereby forming a second sealing surface.

19. A fluid coupling as in claim 18 wherein the annular portion includes a metal reinforcement ring.

20. A fluid coupling as in claim 18 wherein the termination bead of the bellows portion has a part circular cross-section having a diameter greater than that of the thickness of the bellows portion to which it is attached.

21. (canceled)

22. An annular seal for forming a fluid tight seal in a quick connect coupling, the seal including:
a first annular portion having a sealing edge or surface;
a resiliently deformable annular portion attached to and extending from said first annular portion that is compressible, said resiliently deformable annular portion having an arcuate cross-sectional shape, wherein said resiliently deformable annular portion terminates in a single ridge having an arcuate cross-section thereby forming a second annular sealing surface.

23. An annular seal as in claim 22 wherein the thickness of said resiliently deformable annular portion tapers from adjacent said first annular portion to the end of said resiliently deformable annular portion.
